(19) United States
(12) Patent Application Publication
(10) Pub. No.: US 2021/0217068 A1
(43) Pub. Date: Jul. 15, 2021

(54) Commodity Anti-counterfeiting Tracing Method and System Applicable to E-Commerce Platform

(71) Applicant: Song Xu, Zhongshan (CN)

(72) Inventor: Song Xu, Zhongshan (CN)

(21) Appl. No.: 17/218,097

(22) Filed: Mar. 30, 2021

Related U.S. Application Data
(63) Continuation of application No. PCT/CN2019/107978, filed on Sep. 26, 2019.

(30) Foreign Application Priority Data
Sep. 30, 2018 (CN) 201811157081.0
Sep. 24, 2019 (CN) 201910906008.7

(51) Int. Cl. G06Q 30/06; G06Q 20/40

(52) U.S. Cl. CPC G06Q 30/0609; G06Q 20/401

(57) ABSTRACT

The disclosure relates to a commodity anti-counterfeiting tracing method and system applicable to an e-commerce platform. The disclosure includes a commodity identification feature code set on a commodity package, a scan-to-shelve verification segment set in a commodity information publishing flow, and a scan-to-transact verification segment set in a transaction flow. Therefore, scanning to shelve and scanning to sell may be implemented. This may be ensured that a commodity bought by a buyer from the e-commerce platform is certified, and the goodwill of the e-commerce platform may also be improved greatly. Moreover, complete compatibility with an existing standard article numbering system may be achieved, the counterfeit commodities may be prevented effectively from entering each circulation segment of a supply chain, the probability that the counterfeit commodities enter the e-commerce platform for circulation may further be reduced, and the purpose of anti-counterfeiting tracing may be achieved.

### CROSS REFERENCE TO RELATED APPLICATIONS

The present application is a Continuation Application of PCT Application No. PCT/CN2019/107978 filed on Sep. 26, 2019, which claims the benefit of Chinese Patent Application Nos. 201811157081.0 filed on Sep. 30, 2018 and 201910906008.7 filed on Sep. 24, 2019. All the above are hereby incorporated by reference in their entirety.

### TECHNICAL FIELD

The disclosure belongs to the technical field of online e-commerce platforms and particularly relates to a commodity anti-counterfeiting tracing method and system applicable to an e-commerce platform.

### BACKGROUND

Today, online shopping has become the most popular shopping mode and gradually replaced an offline shopping mode due to the advantages of quickness, convenience, competitive price, and the like. However, in recent years, various major online e-commerce platforms have been confronted with some problems that they have been tried to solve but cannot, i.e., the problems of circulation of counterfeit commodities and infringing upon intellectual property. Consequently, the major online e-commerce platforms are often complained about and prosecuted. For this reason, some online e-commerce platforms put lots of human and material resources to set up departments dedicated to handling the problems of complaints and prosecutions, etc. However, the circulation of counterfeit commodities still cannot be eradicated completely and stopped, namely the condition of infringing upon intellectual property still exists.

In addition, article number is digitalized “article” information and the cornerstone of modernization and informatization. Ultimately, new concepts, new technologies, and new applications emerging continuously in recent years, such as supply chain innovation, the Internet of things, big data, cloud computing, and the smart planet, are still based on article numbering. A data carrier of an article numbering system is mainly a barcode, and a radiofrequency tag is also in exploration as new technology. At present, GS1 system numbering (of course, another code system such as Codebar is also included) is applied to a standard article numbering system most extensively. At present, most universal barcodes for commodities or goods circulated in domestic and international markets adopt GS1 system numbers.

Supply chain standardization, informatization, and intellectualization are innovation directions, but the circulation of counterfeit products cannot be prevented by the universal barcode machine reading that a conventional supply chain informatization technology depends on.

In most of the existing “one article one code” anti-counterfeiting tracing technical measures, an “anti-counterfeiting code” is taken as an anti-counterfeiting feature. This technology has the shortcoming that an anti-counterfeiting tracing function cannot be realized once the anti-counterfeiting feature is copied in a commodity circulation process. Of course, adopting a covering or hiding the anti-counterfeiting feature in a package can overcome the shortcoming but brings the problem of inconvenience for the query. More importantly, these anti-counterfeiting tracing technical measures are isolated, and the circulation of counterfeit commodities in e-commerce platforms cannot be eradicated completely from the source.

### SUMMARY

For solving the problems in a conventional art, the disclosure provides a commodity anti-counterfeiting tracing method and system applicable to an e-commerce platform. Scanning to shelve and scanning to sell may be implemented, counterfeit commodities may be prevented effectively from entering the e-commerce platform for circulation, and the quality of commodities to be sold in the e-commerce platform and the goodwill of the e-commerce platform may be ensured. Moreover, complete compatibility with an existing standard article numbering system may be achieved, the counterfeit commodities may be prevented effectively from entering each circulation segment of a supply chain, the probability that the counterfeit commodities enter the e-commerce platform for circulation may further be reduced, and the purpose of anti-counterfeiting tracing may be achieved.

For solving the technical problems, the disclosure is implemented through the following technical solutions.

A commodity anti-counterfeiting tracing method applicable to an e-commerce platform includes that:

a commodity identification feature code is set on a commodity package to implement one article correspond to one code, an information storage system storing the commodity identification feature code;

a shelving verification segment is set in a commodity information publishing flow: a seller client of the e-commerce platform performs scanning identification on a commodity identification feature code on a commodity to be sold, uploads it to a server of the e-commerce platform for verification, and after successful verification, enters a next segment of the commodity information publishing flow; and

a transaction verification segment is set in a transaction flow: the seller client performs scanning identification on the commodity identification feature code of the commodity to be sold, uploads it to the server of the e-commerce platform for verification, and after successful verification, enters a next segment of the transaction flow.

Furthermore, the shelving verification segment is specifically as follows: first, the seller client of the e-commerce platform performs scanning identification on the commodity identification feature code on the commodity to be sold and uploads it to the server of the e-commerce platform; then, the server of the e-commerce platform performs consistency verification on the commodity identification feature code uploaded by the seller client according to the commodity identification feature code stored in the information storage system; and finally, after successful verification, the next segment of the commodity information publishing flow is entered.

Furthermore, the transaction verification segment is specifically as follows: first, the seller client performs scanning identification on the commodity identification feature code of the commodity to be sold and uploads it to the server of the e-commerce platform; then, the server of the e-commerce platform performs consistency verification on the commodity identification feature code presently uploaded by the seller client according to commodity identification feature code information stored in the information storage system or historical data of a commodity identification feature code uploaded by the seller client; and finally, after successful verification, the next segment of the transaction flow is entered.

Furthermore, a scanning identification system set in each circulation segment of a supply chain reads and identifies the identification feature code of the commodity and generates identification information, the identification information including the commodity identification feature code and an ownership tag of the scanning identification system; and then the identification information is sent to the information storage system for storage through the server of the e-commerce platform or directly to complete collection of supply chain data corresponding to the commodity identification feature code for a convenient query of the supply chain data, thereby implementing commodity tracing.

Furthermore, the server of the e-commerce platform or the information storage system determines whether a scanning identification system owner of the uploaded commodity identification feature code is a present owner of the commodity corresponding to the commodity identification feature code or not according to the supply chain data and/or a commodity circulation record of the e-commerce platform, and the identification information of the commodity uploaded by the scanning identification system except for the present owner of the commodity not be collected as supply chain data.

Furthermore, in the commodity information publishing flow, the server of the e-commerce platform only publishes commodity information uploaded by the scanning identification system determined as the present owner of the commodity.

Furthermore, the commodity identification feature code set on the commodity package is a combined identification code including universal commodity barcode information.

Furthermore, the commodity identification feature code set on the commodity package is a combined identification code formed by combining a universal commodity barcode and an identification code presented as an uncovered code, the identification code being a character or a one-dimensional/two-dimensional barcode and set in the same identification region of the commodity package separately with the universal commodity barcode, or the identification code presented as the uncovered code, or color and/or gray information overlaid on the universal commodity barcode.

A commodity anti-counterfeiting tracing system applicable to an e-commerce platform includes:

a commodity identification feature code, set on a commodity package;

an information storage system, configured to store commodity identification feature code information, identification information uploaded by a scanning identification system in each circulation segment of a supply chain, and requests for processing the data and performing data exchange and response query with each member device in the commodity anti-counterfeiting tracing system;

a server of the e-commerce platform configured to process a commodity information publishing flow and a transaction flow and verify commodity identification feature code information uploaded by a seller client in the flows; and

the seller client of the e-commerce platform, performing scanning identification on a commodity identification feature code on a commodity to be sold and uploading it to the server of the e-commerce platform in the commodity information publishing flow and the transaction delivery flow.

Furthermore, the commodity identification feature code is a combined identification code including a universal commodity barcode; and the system further includes the scanning identification system set in each circulation segment of the supply chain, configured to read and identify the commodity identification feature code, generate the identification information and then send the identification information to the information storage system by a communication device arranged in the system through a network to complete collection of the supply chain data of the information storage system.

The disclosure has the following beneficial effects.

Through the technical solutions of the disclosure, scanning to shelve and scanning to sell may be implemented, counterfeit commodities may be prevented effectively from entering the e-commerce platform for circulation, it may be ensured that a commodity bought by a buyer of the e-commerce platform is certified, and the goodwill of the e-commerce platform may also be improved greatly. Moreover, complete compatibility with an existing standard article numbering system may be achieved, the counterfeit commodities may be prevented effectively from entering each circulation segment of the supply chain, the probability that the counterfeit commodities enter the online e-commerce platform for circulation may further be reduced, and the purpose of anti-counterfeiting tracing may be achieved.

### BRIEF DESCRIPTION OF THE DRAWINGS

FIG. 1 is a flowchart of an embodiment of a commodity anti-counterfeiting tracing method applicable to an e-commerce platform according to the disclosure; and

FIG. 2 is a structure diagram of an embodiment of a supply chain data collection and verification system compatible with standard article numbering for a shopping platform according to the disclosure.

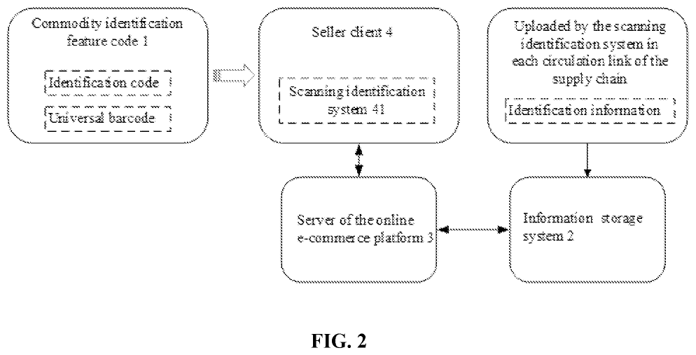

### DETAILED DESCRIPTION OF THE EMBODIMENTS

For making the purposes, technical solutions, and advantages of the disclosure clearer, the disclosure will further be described below in combination with the drawings and embodiments in detail. The specific embodiments described herein are adopted not to limit the disclosure but only to explain the disclosure.

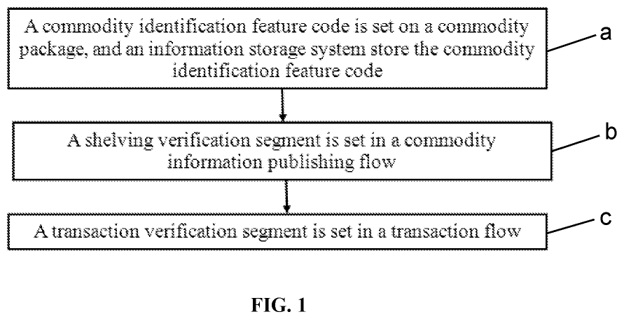

As shown in FIG. 1,

a commodity anti-counterfeiting tracing method applicable to an e-commerce platform according to an embodiment of the disclosure includes the following steps.

In Step a, a commodity identification feature code is set (made in manners of printing, stamping, laser marking, and the like) on a commodity package to implement one article one code, an information storage system storing the commodity identification feature code.

In Step b, a shelving verification segment is set in a commodity information publishing flow: a seller client of the e-commerce platform performs scanning identification on a commodity identification feature code on a commodity to be sold, uploads it to a server of the e-commerce platform for verification, and after successful verification, enters a next segment of the commodity information publishing flow.

In Step c, a transaction verification segment is set in a transaction flow: the seller client performs scanning identification on the commodity identification feature code of the commodity to be sold, uploads it to the server of the e-commerce platform for verification, and after successful verification, enters a next segment of the transaction flow.

The commodity identification feature code may be a combined identification code including universal commodity barcode information. For example, the commodity identification feature code set on the commodity package is a combined identification code formed by combining a universal commodity barcode and an identification code presented as an uncovered code (the identification code may be a random code or a code adopting a fixed coding rule), the identification code being a character or a one-dimensional/two-dimensional barcode and set in the same identification region of the commodity package separately with the universal commodity barcode (of course, the commodity identification feature code set on the commodity package may also be the identification code presented as the uncovered code only, or color and/or gray information overlaid on the universal commodity barcode). A specific collection method for the commodity identification feature code stored in the information storage system is as follows: a scanning identification system set in each circulation segment of a supply chain reads and identifies the identification feature code and generates identification information, the identification information including the commodity identification feature code and an ownership tag of the scanning identification system; and then the identification information is sent to the information storage system for storage through the server of the e-commerce platform or directly to complete collection of supply chain data corresponding to the commodity identification feature code for a convenient query of the supply chain data, thereby implementing commodity tracing. The shelving verification segment is specifically as follows: first, the seller client of the e-commerce platform performs scanning identification on the identification feature code on the commodity to be sold and uploads it to the server of the e-commerce platform; then, the server of the e-commerce platform performs consistency verification on the identification feature code uploaded by the seller client according to the identification feature code stored in the information storage system; and finally, after successful verification, the next segment of the commodity information publishing flow is entered. In the commodity information publishing flow, the server of the e-commerce platform only publishes commodity information uploaded by a scanning identification system determined as the present owner of the commodity. The transaction verification segment is specifically as follows: first, the seller client performs scanning identification on the identification feature code of the commodity to be sold and uploads it to the server of the e-commerce platform; then, the server of the e-commerce platform performs consistency verification on the commodity identification feature code presently uploaded by the seller client according to commodity identification feature code information stored in the information storage system or historical data of a commodity identification feature code uploaded by the seller client; and finally, after successful verification, the next segment of the transaction flow is entered. Moreover, the scanning identification system set in each circulation segment of the supply chain reads and identifies the commodity identification feature code and generates identification information, the identification information including the commodity identification feature code and an ownership tag of the scanning identification system; and then the identification information is sent to the information storage system for storage through the server of the e-commerce platform or directly to complete collection of supply chain data corresponding to the commodity identification feature code, and the server of the e-commerce platform or the information storage system determines whether a scanning identification system owner of the uploaded commodity identification feature code is a present owner of the commodity corresponding to the commodity identification feature code or not according to the supply chain data and/or a commodity circulation record of the e-commerce platform, and the identification information of the commodity uploaded by the scanning identification system except for the present owner of the commodity not be collected as supply chain data.

The disclosure also provides a commodity anti-counterfeiting tracing system applicable to an e-commerce platform, which includes a commodity identification feature code 1, an information storage system 2, a server of the e-commerce platform 3, and a seller client of the e-commerce platform 4. The commodity identification feature code 1 may be a combined identification code including a universal commodity barcode and is set on a commodity package (of course, the commodity identification feature code set on the commodity package may also be an identification code presented as an uncovered code only, or color and/or gray information overlaid on the universal commodity barcode). The information storage system 2 is mainly configured to store commodity identification feature code information, identification information uploaded by a scanning identification system in each circulation segment of a supply chain, and requests for processing the data and performing data exchange and response query with each member device in the commodity anti-counterfeiting tracing system. The server of the e-commerce platform 3 is mainly configured to process a commodity information publishing flow and a transaction flow and verify commodity identification feature code information uploaded by the seller client in the flows. The seller client of the e-commerce platform 4 performs scanning identification on a commodity identification feature code on a commodity to be sold and uploads it to the server of the e-commerce platform in the commodity information publishing flow and the transaction delivery flow.

Accordingly, through the commodity anti-counterfeiting tracing method and system applicable to the e-commerce platform in the disclosure, scanning to shelve and scanning to sell may be implemented, counterfeit commodities may be prevented effectively from entering the e-commerce platform for circulation, it may be ensured that all commodities sold in the e-commerce platform are certified, and the goodwill of the e-commerce platform may also be improved greatly. In addition, complete compatibility with an existing standard article numbering system may be achieved, the counterfeit commodities may be prevented effectively from entering each circulation segment of the supply chain, and the probability that the counterfeit commodities enter the online e-commerce platform for circulation may further be reduced. Meanwhile, a seller of the online e-commerce platform and each circulation segment of the supply chain may complete collection of the supply chain data and “one article one code” anti-counterfeiting tracing quickly at the same time only by one scanning operation, warehousing operations in each circulation segment in the supply chain are simplified effectively, the operation time is shortened, the length of the identification code may also be reduced greatly, the processed data size is reduced, and the data collection and identification efficiency are improved. Moreover, the system is simple in structure, likely to be accepted by each merchant of the supply chain and favorable for overall popularization and application.

In addition, the system further includes the scanning identification system set in each circulation segment of the supply chain (the scanning identification system may include an optical lens subsystem, a photoelectric sensing subsystem, an analogue-to-digital conversion circuit subsystem and a decoding subsystem, the photoelectric sensing subsystem is a photoelectric conversion module for converting an optical signal into an electric signal, and the decoding subsystem is an identification system capable of simultaneously decoding the universal commodity barcode and the identification code), mainly configured to read and identify the commodity identification feature code, generate the identification information and then send the identification information to the information storage system by a communication device arranged in the system through a network to complete collection of the supply chain data of the information storage system and “one article one code” anti-counterfeiting tracing.

The above is the preferred implementation mode of the disclosure. It is to be pointed out that those of ordinary skill in the art may also make several improvements and embellishments without departing from the principle of the disclosure and these improvements and embellishments shall also fall within the scope of protection of the disclosure.

What is claimed is:

1. A commodity anti-counterfeiting tracing method applicable to an e-commerce platform, comprising:
setting a commodity identification feature code on a commodity package to implement one article one code, an information storage system storing the commodity identification feature code;
setting a shelving verification segment in a commodity information publishing flow: by a seller client of the e-commerce platform, performing scanning identification on a commodity identification feature code on a commodity to be sold, uploading it to a server of the e-commerce platform for verification, and after successful verification, entering a next segment of the commodity information publishing flow; and
setting a transaction verification segment in a transaction flow: by the seller client, performing scanning identification on the commodity identification feature code of the commodity to be sold, uploading it to the server of the e-commerce platform for verification, and after successful verification, entering a next segment of the transaction flow.

2. The commodity anti-counterfeiting tracing method applicable to the e-commerce platform as claimed in claim 1, wherein the shelving verification segment is specifically as follows: first, the seller client of the e-commerce platform performs scanning identification on the commodity identification feature code on the commodity to be sold and uploads it to the server of the e-commerce platform; then, the server of the e-commerce platform performs consistency verification on the commodity identification feature code uploaded by the seller client according to the commodity identification feature code stored in the information storage system; and finally, after successful verification, the next segment of the commodity information publishing flow is entered.

3. The commodity anti-counterfeiting tracing method applicable to the e-commerce platform as claimed in claim 1, wherein the transaction verification segment is specifically as follows: first, the seller client performs scanning identification on the commodity identification feature code of the commodity to be sold and uploads it to the server of the e-commerce platform; then, the server of the e-commerce platform performs consistency verification on the identification feature code presently uploaded by the seller client according to commodity identification feature code information stored in the information storage system or historical data of a commodity identification feature code uploaded by the seller client; and finally, after successful verification, the next segment of the transaction flow is entered.

4. The commodity anti-counterfeiting tracing method applicable to the e-commerce platform as claimed in claim 1, wherein a scanning identification system set in each circulation segment of a supply chain reads and identifies the identification feature code of the commodity and generates identification information, the identification information comprising the commodity identification feature code and an ownership tag of the scanning identification system; and then the identification information is sent to the information storage system for storage through the server of the e-commerce platform or directly to complete collection of supply chain data corresponding to the commodity identification feature code for a convenient query of the supply chain data, thereby implementing commodity tracing.

5. The commodity anti-counterfeiting tracing method applicable to the e-commerce platform as claimed in claim 4, wherein the server of the e-commerce platform or the information storage system determines whether a scanning identification system owner of the uploaded commodity identification feature code is a present owner of the commodity corresponding to the commodity identification feature code or not according to the supply chain data and/or a commodity circulation record of the e-commerce platform, and the identification information of the commodity uploaded by the scanning identification system except for the present owner of the commodity not be collected as supply chain data.

6. The commodity anti-counterfeiting tracing method applicable to the e-commerce platform as claimed in claim 5, wherein, in the commodity information publishing flow, the server of the e-commerce platform only publishes commodity information uploaded by the scanning identification system determined as the present owner of the commodity.

7. The commodity anti-counterfeiting tracing method applicable to the e-commerce platform as claimed in claim 1, wherein the commodity identification feature code set on the commodity package is a combined identification code comprising universal commodity barcode information.

8. The commodity anti-counterfeiting tracing method applicable to the e-commerce platform as claimed in claim 7, wherein the commodity identification feature code set on the commodity package is a combined identification code formed by combining a universal commodity barcode and an identification code presented as an uncovered code, the identification code being a character or a one-dimensional/two-dimensional barcode and set in the same identification region of the commodity package separately with the universal commodity barcode.

9. The commodity anti-counterfeiting tracing method applicable to the e-commerce platform as claimed in claim 1, wherein the commodity identification feature code set on the commodity package is the identification code presented as the uncovered code.

10. The commodity anti-counterfeiting tracing method applicable to the e-commerce platform as claimed in claim 1, wherein the commodity identification feature code set on the commodity package is color and/or gray information overlaid on the universal commodity barcode.

11. A commodity anti-counterfeiting tracing system applicable to an e-commerce platform, comprising:
a commodity identification feature code, set on a commodity package;
an information storage system, configured to store commodity identification feature code information, identification information uploaded by a scanning identification system in each circulation segment of a supply chain, and requests for processing the data and performing data exchange and response query with each member device in the commodity anti-counterfeiting tracing system;
a server of the e-commerce platform configured to process a commodity information publishing flow and a transaction flow and verify commodity identification feature code information uploaded by a seller client in the flows; and the seller client of the e-commerce platform, performing scanning identification on a commodity identification feature code on a commodity to be sold and uploading it to the server of the e-commerce platform in the commodity information publishing flow and the transaction delivery flow.

12. The commodity anti-counterfeiting tracing system applicable to the e-commerce platform as claimed in claim 11, wherein the commodity identification feature code is a combined identification code comprising a universal commodity barcode, or an identification code presented as an uncovered code, or color and/or gray information overlaid on the universal commodity barcode; and the system further comprises the scanning identification system set in each circulation segment of the supply chain, configured to read and identify the commodity identification feature code, generate the identification information and then send the identification information to the information storage system by a communication device arranged in the system through a network to complete collection of the supply chain data of the information storage system.
